(19) United States
(12) Patent Application Publication
(10) Pub. No.: US 2003/0148795 A1
(43) Pub. Date: Aug. 7, 2003

(54) Portable communication device with display area changeable in size

(75) Inventor: Takashi Moriki, Kanagawa (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/356,557

(22) Filed: Feb. 3, 2003

(30) Foreign Application Priority Data
Feb. 4, 2002 (JP) 2002-026911

(51) Int. Cl. H04B 1/08

(52) U.S. Cl. 455/566; 455/575; 455/348

(57) ABSTRACT

A portable communication device has a main unit having a display and a keypad unit, which are engaged so as to slide longitudinally with the displaying area of the display changing in size. A position detector detects a position of the main unit relative to the keypad unit by determining which one of a plurality of predetermined positions is the position of the main unit. The information to be displayed is processed depending on the position of the main unit so that the information is displayed in the displaying area of the display.

### BACKGROUND OF THE INVENTION

1. Field of the Invention

The present invention relates to a portable communication device such as a mobile telephone device or a mobile information terminal, and in particular to a portable communication device having a function of changing a displaying area of a display device.

2. Description of the Related Art

In recent years, a mobile telephone device has become to be used not only just as a telephone but also as a portable information terminal having various additional functions, for example, browsing information on the Internet, E-mail transmission/reception and the like. Accordingly, an increasing amount of data becomes to be displayed on the display device. In such a situation, the display device is becoming increasingly larger in size.

In order to ensure a large-size display area, some portable telephone devices employ a slide structure such that a keypad-equipped unit is slidably engaged with a display-equipped unit. Such a slide-type portable telephone device has been disclosed in, for example, Japanese patent application unexamined publication No. 2001-24762 or 11-259207.

In the slide-type portable telephone device disclosed in the above publication (No. 2001-24762), when the portable telephone device is retracted or closed, only an upper portion of the display is in sight, where only necessary information for telephone communication such as destination number, battery indicator, electric field strength and the like are displayed. When the portable telephone device is extended or opened, the whole screen of the display comes into sight and its display orientation is changed from vertical to horizontal by calling and running a display data conversion program, allowing easy reading of a long string of characters.

Similarly, in the slide-type portable telephone device disclosed in the above publication (No. 11-259207), the displaying area of the display-equipped unit can be extended to the full screen thereof by sliding the keypad-equipped unit down.

However, the above prior arts can provide either the minimum displaying area or the maximum displaying area by sliding the keypad-equipped unit with respect to the display-equipped unit. Accordingly, it is difficult to set the displaying area to an appropriate size for information to be displayed.

### SUMMARY OF THE INVENTION

An object of the present invention is to provide a portable communication device and a display area control method, which can readily change its displaying area to an appropriate size.

According to the present invention, a portable communication device includes: a first unit having at least a display section in one surface thereof; a second unit having at least an input section on one outer surface thereof, wherein the second unit is engaged with the first unit so as to slide longitudinally and wherein a displaying area of the display changes in size by sliding the first unit relative to the second unit; a position detector for detecting a position of the first unit relative to the second unit by determining which one of a plurality of predetermined positions is the position of the first unit; and a processor for processing information to be displayed depending on the position of the first unit so that the information is displayed in the displaying area of the display.

Preferably, the first unit has a plurality of first contacts each corresponding to the plurality of predetermined positions, and the second unit has a second contact which is allowed to be electrically connected to any of the plurality of first contacts by sliding the first unit relative to the second unit. The position detector detects the position of the first unit by determining which one of the plurality of first contacts is electrically connected to the second contact.

When one of the plurality of first contacts is electrically connected to the second contact, the input section of the second unit is electrically connected to the first unit to transfer input data to the first unit.

The processor may divide the displaying area of the display into a plurality of display sections depending on the position of the first unit. The processor may scale an image to be displayed depending on the position of the first unit so as to display the image within the displaying area of the display.

According to another aspect of the present invention, in the portable communication device, a display area control method includes the steps of: detecting a position of the first unit relative to the second unit in stepwise manner; and making the displaying area of the display active to display information thereon.

The position of the first unit may be detected by determining which one of a plurality of predetermined positions is the position of the first unit

As described above, according to the present invention, a user can change the size of a displaying area by sliding the first and second units and the information to be displayed is processed so as to be displayed within the displaying area. Accordingly, the user can easily select a desired one of predetermined displaying area sizes by only sliding. For example, in the case of a horizontally-oriented image, the first unit is extended from the second unit to the extent of an appropriate position to make the displaying area long so as to be suitable for viewing the horizontally-oriented image.

### BRIEF DESCRIPTION OF THE DRAWINGS

FIG. 1A is a plan view of a portable communication device when retracted according to an embodiment of the present invention;

FIG. 1B is a sectional view of the portable communication device shown in FIG. 1A;

FIG. 2A is a plan view of a portable communication device when extended by one step according to the embodiment of the present invention;

FIG. 2B is a sectional view of the portable communication device shown in FIG. 2A;

FIG. 3 is a block diagram showing a circuit structure of a portable communication device according to the embodiment of the present invention; and

FIG. 4 is a flowchart showing a displaying area size control of the portable communication device according to the embodiment of the present invention.

### DESCRIPTION OF THE PREFERRED EMBODIMENT

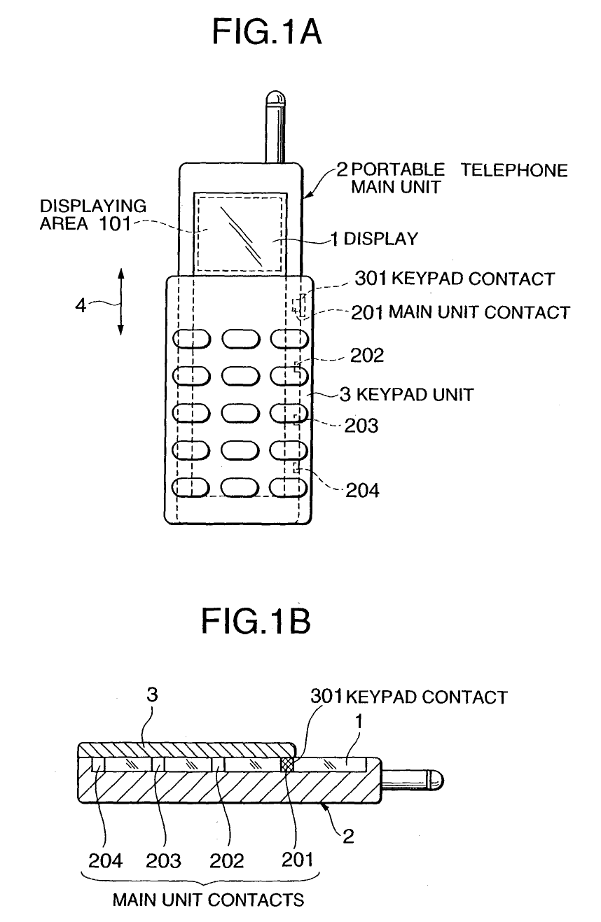

Referring to FIGS. 1A and 1B, a portable telephone device according to an embodiment of the present invention is composed of a main unit 2 and a keypad unit 3, which are coupled to be relatively slidable in longitudinal directions 4. More specifically, the main unit 2 has guide grooves formed on both longitudinal sides thereof. The keypad unit 3 is engaged with these guide grooves to longitudinally slide. The main unit 2 is equipped with a display 1 on the front thereof and further has necessary circuits therein. The keypad unit 3 is equipped with a keypad including a ten-key.

In the present embodiment, the main unit 2 has a plurality of main unit contacts on one side thereof. The keypad unit 3 has a keypad contact 301 on one inner side thereof facing the one side of the main unit 2 provided with the main unit contacts. The plurality of main unit contacts are spaced a predetermined distance. Each space between adjacent main unit contacts and the space between both end main unit contacts may be determined depending on the size of a displaying area 101. The displaying area 101, as described later, protrudes from the keypad unit 3 to be in sight and is made active to display information. In this example, four main unit contacts 201-204 are provided in the main unit 2. In other words, the size of a displaying area 101 can be changed in four steps.

The keypad contact 301 comes in electrical contact with one of the main unit contacts 201-204. In FIGS. 1A and 1b, the keypad contact 301 is electrically connected to the main unit contact 201. As described later, the displaying area 101 is determined depending on which one of the main unit contacts 201-204 is electrically connected to the keypad contact 301.

Preferably, the keypad contact 301 retractably protrudes from the one inner side of the keypad unit 3 and each of the main unit contacts 201-204 is formed like a recess so as to be engaged with the protrusion of the keypad contact 301. Anyway, it is necessary to electrically connect the keypad contact 301 to an arbitrary one of the main unit contacts 201-204 so that an input signal such as a depressed-key code of the keypad unit 3 is transferred to the main unit 2.

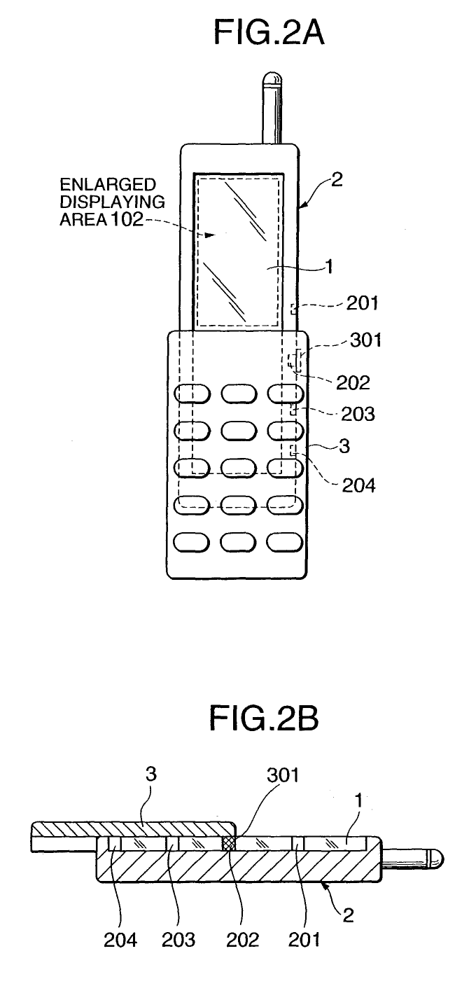

As shown in FIGS. 2A and 2B, the main unit 2 is relatively extended by one step and thereby the keypad contact 301 is electrically connected to the main unit contact 202. Therefore, the displaying area 102 of the display 1 becomes larger than that in the retracted state as shown in FIGS. 1A and 1B.

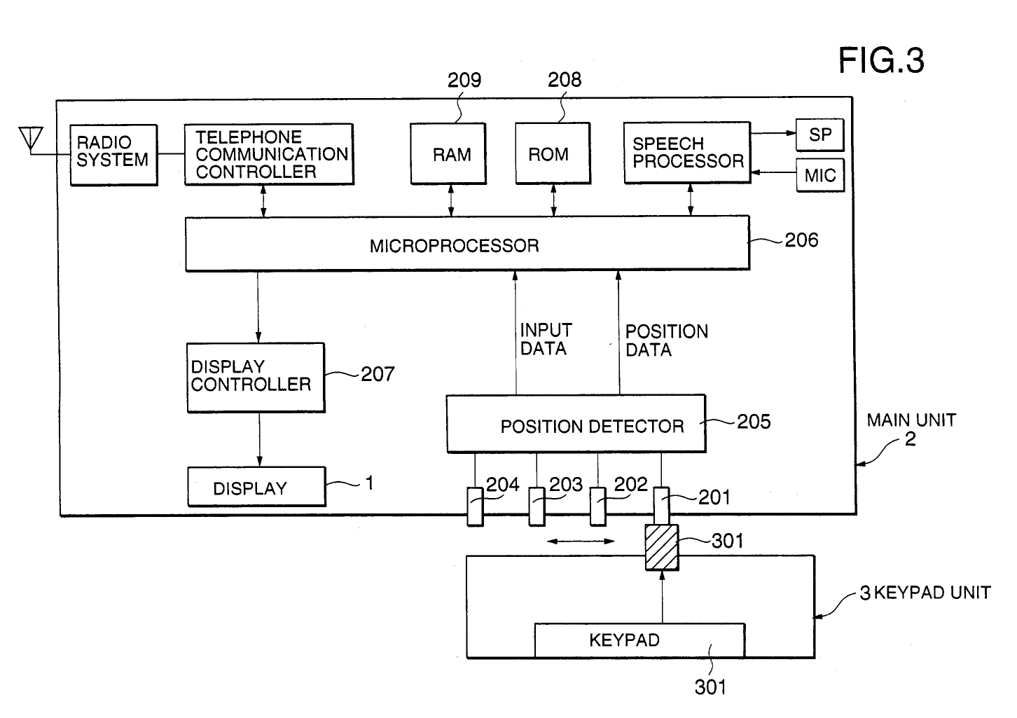

Referring to FIG. 3, the main unit 2 includes a mobile telephone circuit and other necessary circuits. More specifically, the main unit contacts 201-204 are connected to a position detector 205, which detects a position of the keypad unit 3 to output its position data and input data to a program-controlled processor 206. The position detector 205 determines which one of the main unit contacts 201-204 is presently connected to the keypad contact 301 and whether a contact change occurs.

The processor 206 controls a display controller 207, telephone communication controller, speech processor and other circuits. Control programs including a displaying area change program and a display data processing program are stored in a read-only memory 208 and run on the processor 206 to perform predetermined telephone functions, displaying area size changing function and other additional functions.

Under control of the processor 206, the display controller 207 controls the display 1 so that information processed by the processor 206 is displayed thereon. Such information to be displayed is stored in a random access memory 209 and is processed by the processor 206 depending on the position data so as to display the information within a displaying area of the display 1.

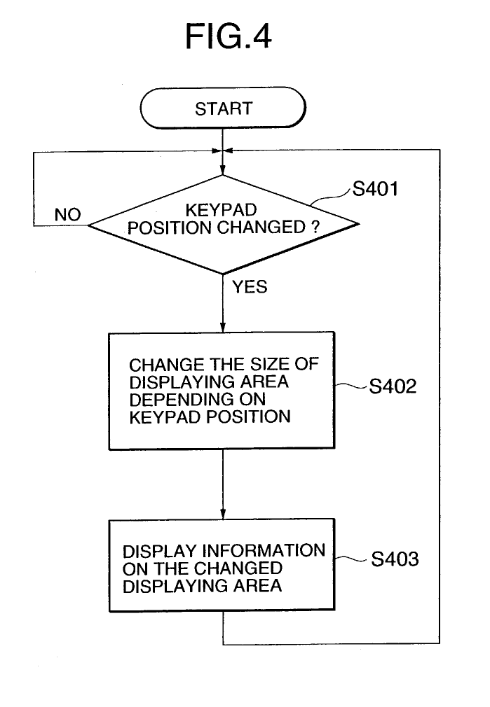

Referring to FIG. 4, the processor 206 on which the displaying area change program is running monitors the position data of the position detector 205 to determine whether a keypad position has been changed (step S401). The position detector 205 produces position data indicating a presently connected one of the main unit contacts 201-204 and outputs it to the processor 206. To ensure position change detection, for example, the position detector 205 determines a position change when one second has elapsed since the keypad contact 301 stops at one of the main unit contacts 201-204.

When it is determined that a keypad position has been changed (YES in step S401) , the processor 206 changes the size of a displaying area depending on the detected keypad position (step S402) and processes (e.g. scales or divides) information to be displayed so as to display it within the changed displaying area of the display 1 (step S403).

For example, in the retracted state as shown in FIG. 1A, the processor 206 sets an active area of the display 1 to the displaying area 101 and processes and/or scales an image to be displayed so that the image is appropriately displayed within the displaying area 101. In this state, only basic information for telephone communication such as destination number, battery indicator, electric field strength and the like may be displayed in the displaying area 101

Thereafter, when the main unit 2 is extended by one step as shown in FIG. 2A, the processor 206 receives the position data indicating that the main unit contact 202 is electrically connected to the keypad contact 301. Accordingly, the processor 206 sets an active area of the display 1 to the enlarged displaying area 102 and processes or rescales the image to be displayed so that the image is appropriately displayed within the enlarged displaying area 102. In this state, the enlarged displaying area 102 may be divided into a plurality of sections, for example, a basic information section and an information editor section. It is the same with other keypad positions.

In this manner, the portable telephone device can provide a stepwise change of the displaying area by sliding the main unit 2 and the keypad unit 2.

When the main unit 2 is extended to the extent that a displaying area becomes long, the processor 206 may change the orientation of an image between vertically and horizontally so as to provide an easy-to-read display as well as efficient use of the displaying area.

1. A portable communication device comprising:
a first unit having at least a display section in one surface thereof;
a second unit having at least an input section on one outer surface thereof, wherein the second unit is engaged with the first unit so as to slide longitudinally and wherein a displaying area of the display changes in size by sliding the first unit relative to the second unit;
a position detector for detecting a position of the first unit relative to the second unit by determining which one of a plurality of predetermined positions is the position of the first unit; and
a processor for processing information to be displayed depending on the position of the first unit so that the information is displayed in the displaying area of the display.

2. The portable communication device according to claim 1, wherein
the first unit has a plurality of first contacts each corresponding to the plurality of predetermined positions, and
the second unit has a second contact which is allowed to be electrically connected to any of the plurality of first contacts by sliding the first unit relative to the second unit,
wherein the position detector detects the position of the first unit by determining which one of the plurality of first contacts is electrically connected to the second contact.

3. The portable communication device according to claim 1, wherein the input section of the second unit is electrically connected to the first unit to transfer input data to the first unit when one of the plurality of first contacts is electrically connected to the second contact.

4. The portable communication device according to claim 1, wherein the processor divides the displaying area of the display into a plurality of display sections depending on the position of the first unit.

5. The portable communication device according to claim 1, wherein the processor scales an image to be displayed depending on the position of the first unit so as to display the image within the displaying area of the display.

6. A display area control method in a portable communication device comprising:
a first unit having at least a display section in one surface thereof;
a second unit having at least an input section on one outer surface thereof, wherein the second unit is engaged with the first unit so as to slide longitudinally and wherein a displaying area of the display changes in size by sliding the first unit relative to the second unit,
wherein the method comprises the steps of:
detecting a position of the first unit relative to the second unit in stepwise manner; and
making the displaying area of the display active to display information thereon.

7. The display area control method according to claim 6, wherein the position of the first unit is detected by determining which one of a plurality of predetermined positions is the position of the first unit
